(19) United States
(12) Patent Application Publication
(10) Pub. No.: US 2026/0213157 A1
(43) Pub. Date: Jul. 23, 2026

(54) POSITIVE ELECTRODES AND RECHARGEABLE LITHIUM BATTERIES

(71) Applicant: SAMSUNG SDI CO., LTD., Yongin-si (KR)

(72) Inventors: Sanghee NAM, Yongin-si (KR); Songyul OH, Yongin-si (KR); Soonsung SUH, Yongin-si (KR)

(73) Assignee: SAMSUNG SDI CO., LTD., Yongin-si (KR)

(21) Appl. No.: 19/441,248

(22) Filed: Jan. 6, 2026

(30) Foreign Application Priority Data
Jan. 20, 2025 (KR) 10-2025-0008349

(51) Int. Cl. H01M 4/136; C01B 25/45; H01M 4/02; H01M 4/58; H01M 10/0525; H01M 10/42

(52) U.S. Cl. CPC H01M 4/136; C01B 25/45; H01M 4/5825; H01M 10/0525; H01M 10/4235; C01P 2004/03; C01P 2004/80; C01P 2006/40; H01M 2004/021; H01M 2004/028

(57) ABSTRACT

Provided are a positive electrode and a rechargeable lithium battery, the positive electrode including a positive electrode current collector, a positive electrode active material layer disposed on the positive electrode current collector and including a positive electrode active material, and a coating layer disposed between the positive electrode current collector and the positive electrode active material layer, and including an irreversible positive electrode additive. The irreversible positive electrode additive includes at least one of a lithium cobalt-based oxide and a lithium nickel-based oxide, and further includes a lithium iron-based oxide.

### CROSS-REFERENCE TO RELATED APPLICATION

This application claims priority to Korean Patent Application No. 10-2025-0008349 filed with the Korean Intellectual Property Office on Jan. 20, 2025, the entire contents of which are incorporated herein by reference.

### BACKGROUND

### 1. Field

Positive electrodes and rechargeable lithium batteries are disclosed.

### 2. Description of the Related Art

A portable information device such as, e.g., a cell phone, a laptop, smart phone, and the like, or an electric vehicle, typically uses a rechargeable lithium battery having high energy density and ready portability as a driving power source. Accordingly, a rechargeable lithium battery with high energy density as a driving power source or power storage power source for hybrid or electric vehicles may be advantageous.

Rechargeable lithium batteries typically include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

Transition metal compounds such as lithium cobalt-based oxide, lithium nickel-based oxide, and lithium manganese-based oxide are mainly used as positive electrode active materials for rechargeable lithium batteries, and crystalline carbon materials such as natural graphite or artificial graphite or amorphous carbon materials are used as negative electrode active materials.

### SUMMARY

Some example embodiments include a positive electrode capable of improving initial activation efficiency and shortening activation time, and a rechargeable lithium battery capable of securing desired or improved charge/discharge performance and cycle-life characteristics.

Some example embodiments include a positive electrode including a positive electrode current collector; a positive electrode active material layer disposed on the positive electrode current collector and including a positive electrode active material; and a coating layer disposed between the positive electrode current collector and the positive electrode active material layer, and including an irreversible positive electrode additive. The irreversible positive electrode additive includes at least one of a lithium cobalt-based oxide and a lithium nickel-based oxide, and further includes a lithium iron-based oxide.

Some example embodiments include a rechargeable lithium battery including the positive electrode; a negative electrode; and an electrolyte.

According to some example embodiments, a positive electrode capable of improving initial activation efficiency and shortening activation time and a rechargeable lithium battery capable of securing desired or improved charge/discharge performance and cycle-life characteristics may be provided.

### BRIEF DESCRIPTION OF THE DRAWINGS

FIGS. 1 to 4 are views schematically showing rechargeable lithium batteries according to some example embodiments.

FIG. 5 is a cross-sectional view schematically showing a positive electrode according to some example embodiments.

FIG. 6 is a photograph of a cross-section of the positive electrode manufactured in Example 1 taken using a scanning electron microscope (SEM).

FIG. 7 is a photograph of a cross-section of the positive electrode manufactured in Comparative Example 6 taken using a scanning electron microscope (SEM).

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, and the like, are exaggerated for clarity, and like reference numerals designate like elements throughout the specification. It is understood that when an element such as a layer, film, region, or substrate is referred to as being “on” another element, the element can be directly on the other element or intervening elements may also be present therebetween. In contrast, when an element is referred to as being “directly on” another element, there may not be intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it may be possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

Herein, “thickness” may be measured, for example, from photographs taken with an optical microscope such as a scanning electron microscope.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Positive Electrode

Some example embodiments include a positive electrode including a positive electrode current collector; a positive electrode active material layer disposed on the positive electrode current collector and including a positive electrode active material; and a coating layer disposed between the positive electrode current collector and the positive electrode active material layer, and including an irreversible positive electrode additive. The irreversible positive electrode additive includes at least one of a lithium cobalt-based oxide and a lithium nickel-based oxide, and further includes a lithium iron-based oxide.

Rechargeable lithium batteries are used in various applications due to their high energy density and desired or improved cycle-life characteristics. There is an increasing need to improve the long cycle-life of these rechargeable lithium batteries, and rapid activation of the negative electrode and induction of high undischarged capacity by increasing the reversible lithium content are considered key technologies for improving the long-cycle capacity retention rate of rechargeable lithium batteries.

To this end, physical and electrochemical pre-lithiation methods have been studied to intercalate reversible lithium into the negative electrode in advance. Representative methods of adding irreversible positive electrode additives to the positive electrode active material layer and compensating for reversible lithium consumption by formation at a voltage of about 4 V or higher are being examined to improve the cycle-life of the battery. However, due to the large particle size of the positive electrode additive compared to the particle size of the positive electrode active material, the positive electrode additive may be unevenly distributed within the positive electrode, which reduces electrical conductivity, making initial activation difficult and causing the initial activation process to take a long time.

Accordingly, in some example embodiments, an irreversible additive is introduced into a coating layer between a positive electrode current collector and a positive electrode active material layer, and a coating layer including the irreversible additive is disposed at the lower portion of the positive electrode. A positive electrode active material layer including the positive electrode active material is disposed at the upper portion of the positive electrode, thereby proposing a positive electrode that can increase the initial activation efficiency and shorten the activation time by inducing a substantially uniform reaction according to a regular arrangement.

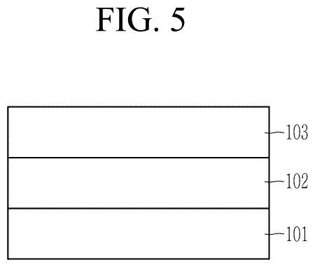

A cross-sectional view schematically showing the structure of a positive electrode according to some example embodiments is illustrated in FIG. 5, and the positive electrode according to some example embodiments includes a positive electrode current collector 101; a positive electrode active material layer 103 disposed on the positive electrode current collector 101 and including a positive electrode active material; and a coating layer 102 disposed between the positive electrode current collector 101 and the positive electrode active material layer 103 and including an irreversible positive electrode additive.

The positive electrode current collector may include an Al thin film, but the positive electrode current collector is not limited thereto.

The positive electrode active material layer includes a positive electrode active material, and the positive electrode active material may be or include a compound capable of reversibly intercalating and deintercalating lithium (lithiated intercalation compound). For example, the positive electrode active material may include a lithium transition metal composite oxide, and examples thereof include at least one of a lithium nickel-based oxide, a lithium cobalt-based oxide, a lithium manganese-based oxide, a lithium iron phosphate-based compound, a cobalt-free lithium nickel-manganese-based oxide, a lithium manganese-rich compound, or a combination thereof.

As an example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5,≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may include, for example, at least one of a lithium nickel-based oxide represented by Chemical Formula 1, a lithium cobalt-based oxide represented by Chemical Formula 2, a lithium iron phosphate-based compound represented by Chemical Formula 3 or 4, a cobalt-free lithium nickel-manganese-based oxide represented by Chemical Formula 5, or a combination thereof.

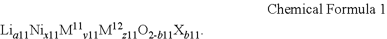

In Chemical Formula 1, 0.9≤a11≤1.8, 0.3≤x11≤1, 0≤y11≤0.7, 0≤z11≤0.7, 0.9≤x11+y11+z11≤1.1, and 0≤b11≤0.1, M¹¹ and M¹² each independently are or include at least one or more of Al, B, Ba, Ca, Ce, Co, Cr, Cu, Fe, Mg, Mn, Mo, Nb, Si, Sn, Sr, Ti, V, W, Y, and Zr, and X is or includes at least one or more of F, P, and S. M¹¹ and M¹² may be different elements.

In Chemical Formula 1, 0.6≤x11≤1, 0≤y11≤0.4, and 0≤z11≤0.4, or 0.8≤x11≤1, 0≤y11≤0.2, and 0≤z11≤0.2.

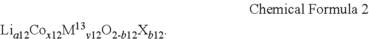

In Chemical Formula 2, 0.9≤a12≤1.8, 0.7≤x12≤1, 0≤y12≤0.3, 0.9≤x12+y12≤1.1, and 0≤b12≤0.1, M¹³ is or includes at least one or more of from Al, B, Ba, Ca, Ce, Cr, Cu, Fe, Mg, Mn, Mo, Ni, Se, Si, Sn, Sr, Ti, V, W, Y, Zn and Zr, and X is or includes at least one or more elements of F, P, and S.

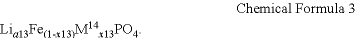

In Chemical Formula 3, 0.90≤a13≤1.5, and 0≤x13≤0.4, and M¹⁴ is or includes at least one or more of Al, B, Ca, Ce, Cr, Cu, La, Mg, Mn, Mo, Nb, Ni, Si, Sn, Sr, Ti, V, W, Y, Zn, Zr, or a combination thereof. Herein, 0.90≤a13≤1.5, for example 0.90≤a13≤1.2, or 0.95≤a13≤1.1. In addition, 0≤x13≤0.4, 0≤x13≤0.3, 0≤x13≤0.2, 0≤x13≤0.1, or 0≤x13≤0.05.

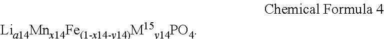

In Chemical Formula 4, 0.90≤a14≤1.5, 0.1≤x14≤0.9, and 0≤y14≤0.9, and M¹⁵ is or includes at least one or more of Al, B, Ca, Ce, Cr, Cu, La, Mg, Mo, Nb, Ni, Si, Sn, Sr, Ti, V, W, Y, Zn, Zr, or a combination thereof. Herein, 0.90≤a14≤1.5, for example 0.90≤a14≤1.2, or 0.95≤a14≤1.1. In addition, 0.1≤x14≤0.9, 0.3≤x14≤0.9, or 0.4≤x14≤0.8, 0≤y14≤0.4, 0≤y14≤0.3, 0≤y14≤0.2, 0≤y14≤0.1, or 0≤y14≤0.05.

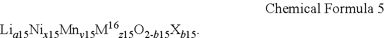

In Chemical Formula 5, 0.9≤a15≤1.8, 0.8≤x15<1, 0<y15≤0.2, 0≤z15≤0.2, 0.9≤x15+y15+z15≤1.1, and 0≤b15≤0.1, M¹⁶ is or includes at least one or more of Al, B, Ba, Ca, Ce, Cr, Fe, Mg, Mo, Nb, Si, Sn, Sr, Ti, V, W, Y, and Zr, and X is or includes at least one or more of F, P, and S.

For example, the positive electrode active material may include a lithium iron phosphate-based compound, and the lithium iron phosphate-based compound may contribute to improving heat resistance and thermal stability, while also increasing capacity or increasing output.

For example, the lithium iron phosphate-based compound may be represented by Chemical Formula 1A or Chemical Formula 2A below.

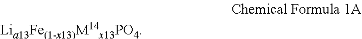

In Chemical Formula 1A, 0.90≤a13≤1.5, 0≤x13≤0.4, and M¹⁴ is or includes at least one of Al, B, Ca, Ce, Cr, Cu, La, Mg, Mn, Mo, Nb, Ni, Si, Sn, Sr, Ti, V, W, Y, Zn, Zr, or a combination thereof,

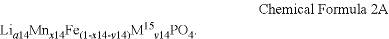

In Chemical Formula 2A, 0.90≤a14≤1.5, 0.1≤x14≤0.9, 0≤y13≤0.9, and M¹⁵ is or includes at least one of Al, B, Ca, Ce, Cr, Cu, La, Mg, Mo, Nb, Ni, Si, Sn, Sr, Ti, V, W, Y, Zn, Zr, or a combination thereof.

For example, M¹⁴ and M¹⁵ of Chemical Formula 1A and Chemical Formula 2A may each independently include at least one of Al, Mg, Ti, V, or a combination thereof.

For example, the lithium iron phosphate-based compound may include at least one of LiFePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, or a combination thereof.

The positive electrode active material including the lithium iron phosphate-based compound is in the form of particles, and an average particle diameter (D₅₀) of the particles may be in a range of about 0.01 μm to about 2 μm, for example, about 0.1 μm to about 1.5 μm, or about 0.2 μm to about 1 μm. The average particle diameter (D₅₀) indicates a diameter of particles having a cumulative volume of 50 volume % in the particle size distribution that is obtained by measuring the size (diameter or major axis length) of about 20 particles at random in a scanning electron microscope image for positive electrode active materials.

In some example embodiments, the lithium iron phosphate-based compound may be in the form of first particles, second particles, or a mixture of first particles and second particles.

The first particles may be or include secondary particles formed by agglomerating plurality of primary particles. The secondary particles may be expressed as an assembly. The secondary particles of the first particles may have a spherical or ellipsoidal shape as the primary particles and are closely agglomerated with each other. An average particle diameter (D₅₀) of the secondary particles of the first particles may be in a range of, for example, about 5 μm to about 20 μm, about 6 μm to about 20 μm, or about 6 μm to about 15 μm. The average particle diameter (D₅₀) of the secondary particles of the first particles may be larger than the average particle diameter (D₅₀) of the single particles of the second particle described below. The average particle diameter (D₅₀) of the primary particles forming the secondary particles of the first particles may be in a range of about 0.1 μm to about 2 μm, about 0.1 μm to about 1.2 μm, or about 0.5 μm to about 0.9 μm, and for example, may be about 10 nm to about 400 nm, about 20 nm to about 300 nm, or about 50 nm to about 200 nm. The average particle diameter (D₅₀) of the first particles may be, for example, obtained by randomly selecting about 30 first particles from an electron microscope image of the lithium iron phosphate-based compound, measuring the particle diameters, and taking the diameter of the particles having a cumulative volume of 50 volume % from the particle size distribution as the average particle diameter. The average particle diameter (D₅₀) of the primary particles forming the secondary particles of the first particles may be determined by measuring the size of about 30 primary particles in an electron microscope image of the surface or cross-section of the first particles and in the particle size distribution, the diameter of particles with a cumulative volume of 50 volume % may be taken as the average particle diameter.

The secondary particles of the first particles may include pores therein, and the porosity may be in a range of about 20% to about 50%. The porosity may be obtained by measuring a ratio of the area occupied by the pores within the secondary particle to the cross-sectional area of the secondary particle using an image analysis program such as Image J, for example, from a scanning electron microscope image of the cross-section of the first particles.

The second particles may be in the form of single particles. The average particle diameter (D₅₀) of the second particles may be less than or equal to about 2 μm, for example, about 0.5 μm to about 2 μm, about 0.5 μm to about 1.5 μm, about 0.6 μm to about 1.2 μm, or about 0.8 μm to about 1.0 μm. The average particle diameter (D₅₀) of the single particles of the second particles may be smaller than the average particle diameter (D₅₀) of the secondary particles of the first particles, and may be equal to or larger than the average particle diameter (D₅₀) of the primary particles forming the secondary particles of the first particles. For example, the average particle diameter (D₅₀) of the second particles may be obtained by randomly or non-systematically selecting about 30 second particles from an electron microscope image of the lithium iron phosphate-based compound, measuring the particle sizes, and taking the diameter of the particles having a cumulative volume of 50 volume % in the particle size distribution as the average particle diameter.

Based on 100 wt % of the positive electrode active material including the lithium iron phosphate-based compound, an amount of the first particles may be in a range of about 20 wt % to about 90 wt %, and an amount of the second particles may be in a range of about 10 wt % to about 80 wt %, for example, an amount of the first particles may be about 40 wt % to about 80 wt % and an amount of the second particles may be about 20 wt % to about 60 wt %, or an amount of the first particles may be about 40 wt % to about 60 wt % and an amount of the second particles may be about 40 wt % to about 60 wt %. When the amounts of the first particle and the second particle satisfy the above ranges, the positive electrode including the first particle and the second particle may have improved energy density and may realize high charge/discharge capacity and efficiency and cycle-life characteristics.

The lithium iron phosphate-based compound may further include a carbon coating layer on the particle surface. For example, the first particle may further include a carbon coating layer on the surface of the secondary particle, and/or on the surface of the primary particles forming the secondary particle. That is, the first particle may further include a carbon coating layer on the surface of the secondary particle, may further include a carbon coating layer on the surface of the primary particles forming the secondary particle, and may further include a carbon coating layer on the surface of the secondary particle and the surface of the primary particles forming the secondary particle. Additionally, the second particle may further include a carbon coating layer on the surface of the single particle. The carbon coating layer may improve electrical conductivity of the lithium iron phosphate-based compound and reduce the resistance of the positive electrode. The carbon coating layer may include amorphous carbon, crystalline carbon, or a combination thereof. The carbon coating layer may be formed, for example, using at least one raw material such as or including at least one of glucose, sucrose, lactose, starch, oligosaccharide, polyoligosaccharide, fructose, cellulose, a polymer of furfuryl alcohol, a block copolymer of ethylene and ethylene oxide, a vinyl resin, a cellulose resin, a phenol resin, a pitch-based resin, and a tar-based resin, or a combination thereof. For example, the carbon coating layer may be formed by arranging the carbon raw materials on the surface of the lithium iron phosphate-based compound particles and then performing a firing process. For example, the carbon raw material and primary particles including the lithium iron phosphate-based compound may be mixed and fired to form a carbon coating layer on the surfaces of the primary particles, and then secondary particles in which the primary particles are agglomerated may be prepared through a post-process, or the carbon raw material and the secondary particles may be mixed and fired to form a carbon coating layer on the surfaces of the secondary particles. Alternatively, the carbon raw material and single particles including the lithium iron phosphate-based compound may be mixed and fired to form a carbon coating layer on the surface of the single particles.

The positive electrode active material layer may further include a binder, a conductive material, or a combination thereof, in addition to the positive electrode active material.

The binder improves binding properties of positive electrode active material particles with one another and with a current collector. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, or nylon, but are not limited thereto.

The conductive material is included to provide electrode conductivity, and any electrically conductive material may be used as a conductive material unless the conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

The amount of the binder and of the conductive material may be in a range of about 0.5 wt % to about 5 wt %, based on 100 wt % of the positive electrode active material layer.

For example, a thickness of the positive electrode active material layer may be in a range of about 10 μm to about 300 μm, about 15 μm to about 200 μm, or about 20 μm to about 100 μm. When the thickness of the positive electrode active material layer satisfies the above range, a high-capacity and high-energy density battery can be realized.

The coating layer is disposed between the positive electrode current collector and the positive electrode active material layer, and includes an irreversible positive electrode additive, wherein the irreversible positive electrode additive includes at least one of a lithium cobalt-based oxide and a lithium nickel-based oxide, and further includes a lithium iron-based oxide.

Some of the lithium included in the positive electrode active material participates in the formation of a solid electrolyte interface (SEI) film during charge and discharge, and is converted to irreversible lithium that no longer participates in the charge and discharge reaction, which may cause a problem of reduced capacity. Accordingly, by using an irreversible positive electrode additive capable of compensating for irreversible lithium, the aforementioned problem can be addressed by acting as a sacrificial positive electrode that can be decomposed in the formation process to provide lithium and does not participate in subsequent charge/discharge.

However, a method of using the aforementioned irreversible positive electrode additive in the positive electrode active material layer may be considered, but in the case of this method, since the particle size of the positive electrode additive is too large compared to the size of the positive electrode active material, the positive electrode additive may be unevenly distributed in the positive electrode active material layer, which may cause an issue in that the electrical conductivity decreases and the initial activation process takes a long time.

Accordingly, in some example embodiments, by introducing an irreversible positive electrode additive into the aforementioned coating layer, the irreversible positive electrode additive may be regularly arranged at the bottom of the positive electrode, thereby causing an initial substantially uniform reaction and improving the activation efficiency. In addition, by arranging a coating layer including an irreversible positive electrode additive in a position close to the positive electrode current collector, activation may be performed at a rate higher than the low rate required for conventional activation, thereby effectively shortening the activation time.

Furthermore, due to the synergistic effect of using at least two, including at least one of the lithium cobalt-based oxide and the lithium nickel-based oxide and the lithium iron-based oxide as an irreversible positive electrode additive included in the coating layer, a large amount of lithium may be provided in the formation process, thereby compensating for a large amount of irreversible lithium, compared to when no irreversible positive electrode additive is used, or when only lithium iron-based oxide is used as the irreversible positive electrode additive, or when only one compound such as or including at least one of lithium cobalt-based oxide and lithium nickel-based oxide is used. In addition, the capacity, efficiency and cycle-life characteristics of rechargeable lithium batteries may be improved.

For example, the lithium cobalt-based oxide may include at least one of LiCoO₂, Li₂CoO₃, Li₃Co₂O₆, Li₆CoO₄, or a combination thereof, and a representative example of the lithium cobalt-based oxide may be Li₆CoO₄. The use of Li₆CoO₄ as the lithium cobalt-based oxide may provide a large amount of lithium in the formation process, thereby compensating for a large amount of irreversible lithium, and thus improving the effect of adding an irreversible positive electrode additive.

For example, the lithium iron-based oxide may include at least one of Li₅FeO₄, LiFeO₂, LiFe₅O₈, LiFe₄O₆, LiFe₃O₄, or a combination thereof, and Li₅FeO₄ may be used as a representative example of the lithium iron-based oxide. The use of Li₅FeO₄ as the lithium iron-based oxide can provide a large amount of lithium in the formation process, thereby compensating for a large amount of irreversible lithium, and thus improving the effect of adding an irreversible positive electrode additive.

For example, the lithium nickel-based oxide may include at least one of LiNiO₂, Li₂NiO₂, or a combination thereof, and Li₂NiO₂ may be used as a representative example of the lithium nickel-based oxide. The use of Li₂NiO₂ as the lithium nickel-based oxide may provide a large amount of lithium in the formation process, thereby compensating for a large amount of irreversible lithium, and thus improving the effect of adding an irreversible positive electrode additive.

For example, the irreversible positive electrode additive may be in the form of particles, and the average particle diameter (D₅₀) of the irreversible positive electrode additive may be larger than the average particle diameter (D₅₀) of the positive electrode active material, and may be in a range of about 1.1 to about 20 times, about 2 to about 15 times, or about 5 to about 10 times the average particle diameter (D₅₀) of the positive electrode active material. In this range, the irreversible positive electrode additive may be substantially uniformly distributed in the coating layer, and a large amount of lithium may be provided in the oxidation process according to the substantially uniform distribution of the irreversible positive electrode additive in the coating layer, thereby further improving the compensation effect of the irreversible lithium.

For example, the average particle diameter (D₅₀) of at least one of the lithium cobalt-based oxide and the lithium nickel-based oxide may be in a range of about 0.5 μm to about 30 μm, about 1 μm to about 25 μm, about 3 μm to about 20 μm, or about 5 μm to about 15 μm. In this range, it may be advantageous to secure the compensation effect of irreversible lithium by providing a lot of lithium in the formation process.

For example, the average particle diameter (D₅₀) of the lithium iron-based oxide may be in a range of about 0.5 μm to about 30 μm, about 1 μm to about 25 μm, about 3 μm to about 20 μm, or about 5 μm to about 15 μm. Within this range, it may be advantageous to secure the compensation effect of irreversible lithium by providing a lot of lithium in the formation process.

For example, the irreversible positive electrode additive may be included in an amount in a range of about 0.5 wt % to about 50 wt %, about 1 wt % to about 40 wt %, or about 5 wt % to about 30 wt % based on 100 wt % of the coating layer. In this range, the initial activation efficiency may be effectively improved through compensation of irreversible lithium by the coating layer without impairing the effect of securing high energy density by the positive electrode active material layer.

For example, at least one of the lithium cobalt-based oxide and the lithium nickel-based oxide may be included in an amount in a range of about 30 wt % to about 90 wt %, about 40 wt % to about 80 wt %, or about 50 wt % to about 75 wt %, based on 100 wt % of the irreversible positive electrode additive. In this range, it may be advantageous to secure improvements in the capacity, efficiency, and cycle-life characteristics of rechargeable lithium batteries.

For example, the lithium iron-based oxide may be included in an amount in a range of about 10 wt % to about 70 wt %, about 20 wt % to about 60 wt %, or about 25 wt % to about 50 wt % based on 100 wt % of the irreversible positive electrode additive. In this range, it may be advantageous to secure improvements in the capacity, efficiency, and cycle-life characteristics of rechargeable lithium batteries.

For example, the irreversible positive electrode additive may include at least one of lithium cobalt-based oxide, lithium nickel-based oxide, and lithium iron-based oxide. When this is satisfied, lithium ions may be deintercalated during the electrochemical activation process, the initial loss of lithium can be effectively compensated for, and the synergistic effect of combining three types of additives may improve or maximize the compensation of irreversible lithium and the effect of adding irreversible positive electrode additives. Accordingly, the effect of improving the capacity, efficiency, and cycle-life characteristics of rechargeable lithium batteries may be improved or maximized.

For example, when the irreversible positive electrode additive includes at least one of lithium cobalt-based oxide, lithium nickel-based oxide, and further includes lithium iron-based oxide, the lithium cobalt-based oxide may be included in an amount in a range of about 1 wt % to about 80 wt %, about 5 wt % to about 70 wt %, about 10 wt % to about 60 wt %, or about 20 wt % to about 50 wt %, based on 100 wt % of the irreversible positive electrode additive, the lithium nickel-based oxide may be included in an amount in a range of about 1 wt % to about 80 wt %, about 5 wt % to about 70 wt %, about 10 wt % to about 60 wt %, or about 20 wt % to about 50 wt %, based on 100 wt % of the irreversible positive electrode additive, and the lithium iron-based oxide may be included in an amount in a range of about 0.5 wt % to about 50 wt %, about 1 wt % to about 40 wt %, about 5 wt % to about 30 wt %, or about 20 wt % to about 30 wt %, based on 100 wt % of the irreversible positive electrode additive. In this range, the synergistic effect of combining three types of additives may improve or maximize the compensation of irreversible lithium and the effect of adding irreversible positive electrode additives. Accordingly, the effect of improving the capacity, efficiency, and cycle-life characteristics of rechargeable lithium batteries may be improved or maximized.

For example, the thickness of the coating layer may be in a range of about 1 μm to about 300 μm, about 2 μm to about 100 μm, about 2 μm to about 80 μm, about 5 μm to about 50 μm, or about 10 μm to about 30 μm. In this range, the thickness of the coating layer may be advantageous in securing the effect of increasing activation efficiency and shortening the initial activation time.

For example, the thickness ratio of the coating layer to a total thickness of the coating layer and the positive electrode active material layer may be in a range of about 2 thickness % to about 50 thickness %, about 10 thickness % to about 50 thickness %, about 10 thickness % to about 40 thickness %, or about 15 thickness % to about 40 thickness %. The effects of improving the initial activation efficiency and shortening the activation time through compensation of irreversible lithium by the coating layer and the effects of securing high energy density by the positive electrode active material layer may be harmonized with each other.

For example, the thickness ratio of the positive electrode active material layer to a total thickness of the coating layer and the positive electrode active material layer may be in a range of about 50 thickness % to about 98 thickness %, about 50 thickness % to about 90 thickness %, about 60 thickness % to about 90 thickness %, or about 60 thickness % to about 85 thickness %. The effect of securing high energy density by the positive electrode active material layer and the effect of improving initial activation efficiency and shortening activation time through compensation of irreversible lithium by the coating layer may be harmonized with each other.

### Rechargeable Lithium Battery

Some example embodiments include a rechargeable lithium battery including the aforementioned positive electrode; a negative electrode; and an electrolyte. As an example, a rechargeable lithium battery may include a positive electrode, a negative electrode, a separator between the positive electrode and the negative electrode, and an electrolyte.

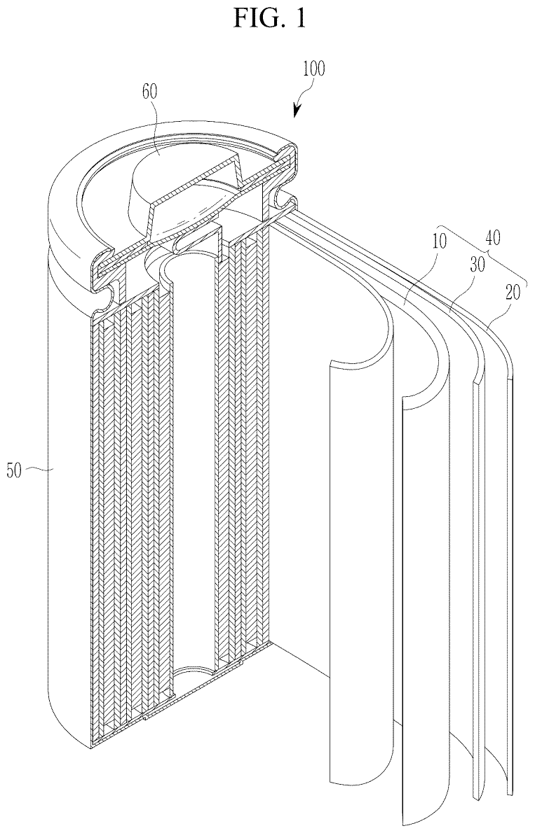

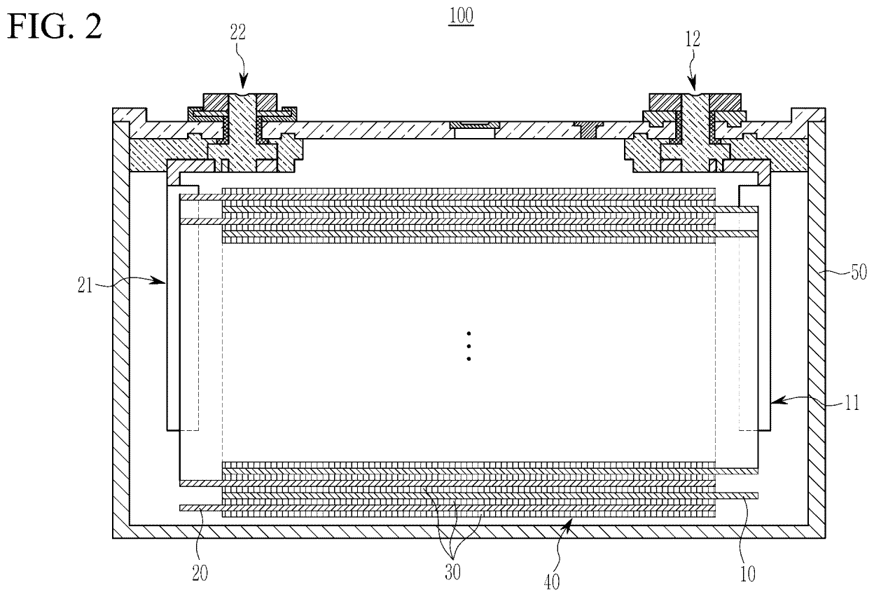

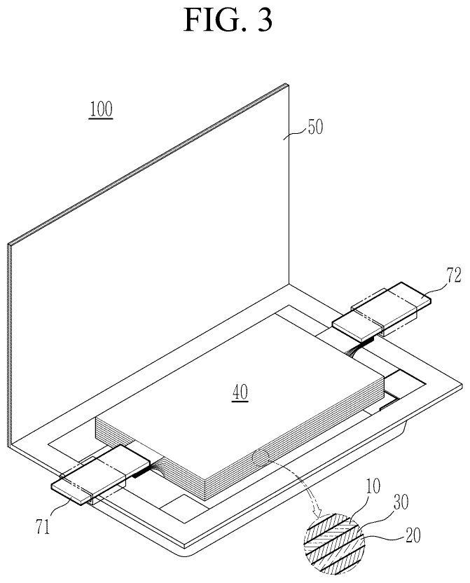

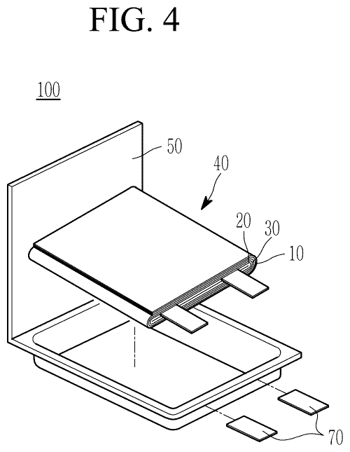

The rechargeable lithium battery may be classified into cylindrical, prismatic, pouch, coin, and the like, depending on the shape thereof. FIGS. 1 to 4 are schematic views showing the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, a rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

### Negative Electrode

The negative electrode may include a current collector, and a negative electrode active material layer on the current collector. The negative electrode active material layer may include a negative electrode active material, and may further include a binder, a conductive material, or a combination thereof.

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example, crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be in a range of, for example, about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, an amount of silicon may be in a range of about 10 wt % to about 50 wt % and an amount of amorphous carbon may be in a range of about 50 wt % to about 90 wt % based on 100 wt % of the silicon-carbon composite. In addition, when the composite includes silicon, amorphous carbon, and crystalline carbon, an amount of silicon may be in a range of about 10 wt % to about 50 wt %, an amount of crystalline carbon may be in a range of about 10 wt % to about 70 wt %, and an amount of amorphous carbon may be in a range of about 20 wt % to about 40 wt % based on 100 wt % of the silicon-carbon composite.

For example, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may exist as silicon alone, in the form of a silicon alloy, or in an oxidized form. The oxidized form of silicon may be represented by SiOₓ (0<x≤2). For example, the atomic content ratio of Si:O, which indicates a degree of oxidation, may be in a range of about 99:1 to about 33:67. As used herein, when a definition is not otherwise provided, an average particle diameter (D₅₀) indicates a particle where a cumulative volume is about 50 volume % in a particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio may be a weight ratio in a range of about 1:99 to about 90:10.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrle, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming a fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the conductive material causes an adverse chemical change in the battery. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

An amount of the negative electrode active material may be in a range of about 95 wt % to about 99.5 wt % based on 100 wt % of the negative electrode active material layer, and an amount of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be in a range of, for example, about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent constitutes a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents, and when two or more types of solvents are used in a mixture, a mixing ratio can be appropriately adjusted according to the desired battery performance, which is typically known to those working in the field.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, and the like.

The lithium salt dissolved in the organic solvent supplies lithium ions in a battery, enables an operation of a rechargeable lithium battery, and improves transportation of the lithium ions between positive and negative electrodes.

Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

A concentration of lithium salt may be within the range of about 0.1 M to about 2.0 M. When the concentration of lithium salt is within the above range, the electrolyte solution has appropriate or desired ionic conductivity and viscosity, and thus desired or improved performance can be achieved and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### (1) Manufacturing of Positive Electrode

15 wt % of Li₆CoO₄ (D₅₀=10 μm), 15 wt % of Li₅FeO₄ (D₅₀=10 μm), 46 wt % of a polyvinylidene fluoride binder, and 24 wt % of a carbon nanotube conductive material were added to an N-Methylpyrrolidone (NMP) solvent, and then mixed to prepare a slurry for forming a coating layer. The slurry for forming a coating layer was coated on both sides of an aluminum foil current collector, and then dried and compressed to form a coating layer with a thickness of about 18 μm.

Subsequently, 96 wt % of LiFePO₄ (D₅₀=1 μm), 2 wt % of carbon nanotube, and 2 wt % of polyvinylidene fluoride were mixed in an NMP solvent to prepare a slurry for forming a positive electrode active material layer. The slurry for forming a positive electrode active material layer was coated on the coating layer, and then dried and compressed to form a positive electrode active material layer with a thickness of about 77 μm, thereby manufacturing a positive electrode.

### (2) Manufacturing of Negative Electrode

97.5 wt % of a graphite negative electrode active material, 1 wt % of carboxymethyl cellulose, and 1.5 wt % of styrene butadiene rubber were mixed in a water solvent to prepare a slurry for forming a negative electrode active material layer. The slurry for forming a negative electrode active material layer was coated on a copper foil, a negative current collector, and then dried and compressed to form a negative electrode active material layer on the negative current collector, thereby manufacturing a negative electrode.

### (3) Manufacturing of Rechargeable Lithium Battery Cell

The positive and negative electrodes were used with a polytetrafluoroethylene separator and an electrolyte solution prepared by mixing ethylene carbonate and dimethyl carbonate in a volume ratio of 3:7 and dissolving 1 M LiPF₆ in the mixed solvent to manufacture a rechargeable lithium battery cell in a common method.

### Example 2

A positive electrode and a rechargeable lithium battery cell were manufactured substantially in the same manner as in Example 1, with a difference that 15 wt % of Li₂NiO₂ (D₅₀=10 μm) was used instead of 15 wt % of Li₆CoO₄ (D₅₀=10 μm) to form the coating layer.

### Example 3

A positive electrode and a rechargeable lithium battery cell were manufactured substantially in the same manner as in Example 1, with a difference that 11.25 wt % of Li₆CoO₄ (D₅₀=10 μm), 11.25 wt % of Li₂NiO₂ (D₅₀=10 μm), and 7.5 wt % of Li₅FeO₄ (D₅₀=10 μm) were used instead of 15 wt % of Li₆CoO₄ (D₅₀=10 μm) and 15 wt % of Li₅FeO₄ (D₅₀=10 μm) to form the coating layer.

### Comparative Example 1

A positive electrode and a rechargeable lithium battery cell were manufactured substantially in the same manner as in Example 1, with a difference that the positive electrode active material layer was directly formed on both sides of the aluminum foil current collector without forming the coating layer in the manufacture of the positive electrode.

### Comparative Example 2

A positive electrode and a rechargeable lithium battery cell were manufactured substantially in the same manner as in Example 1, with a difference that the coating layer was formed by using 30 wt % of Li₅FeO₄ (D₅₀=10 μm) alone but not Li₆CoO₄.

### Comparative Example 3

A positive electrode and a rechargeable lithium battery cell were manufactured substantially in the same manner as in Example 1, with a difference that the coating layer was formed by using 30 wt % of Li₆CoO₄ (D₅₀=10 μm) alone but not Li₅FeO₄.

### Comparative Example 4

A positive electrode and a rechargeable lithium battery cell were manufactured substantially in the same manner as in Example 1, with a difference that the coating layer was formed by using 30 wt % of Li₂NiO₂ (D₅₀=10 μm) but not Li₆CoO₄ and Li₅FeO₄.

### Comparative Example 5

A positive electrode and a rechargeable lithium battery cell were manufactured substantially in the same manner as in Example 1, with a difference that the coating layer was formed by using 15 wt % of Li₆CoO₄ (D₅₀=10 μm) and 15 wt % of Li₂NiO₂ (D₅₀=10 μm) but not Li₅FeO₄.

### Comparative Example 6

A positive electrode and a rechargeable lithium battery cell were manufactured substantially in the same manner as in Example 1, with a difference that the positive electrode was manufactured by not forming the coating layer but forming a positive electrode active material layer with a thickness of about 95 μm, which was formed by mixing 93.49 wt % of LiFePO₄ (D₅₀=1 μm), 1.6 wt % of a carbon nanotube conductive material, 3 wt % of polyvinylidene fluoride, and 1.91 wt % of Li₅FeO₄ (D₅₀=10 μm) to prepare a slurry for forming a positive electrode active material layer and directly coating the slurry on both surfaces of an aluminum foil current collector, in the manufacture of the positive electrode.

### Evaluation Example 1: Evaluation of Scanning Electron Microscope (SEM)

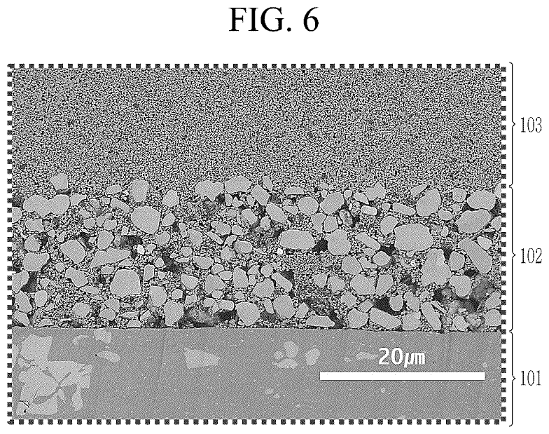

In order to evaluate distribution uniformity of the irreversible positive electrode additives, the positive electrode of Example 1 was taken an image of its cross-section with a scanning electron microscope (SEM), and the image is shown in FIG. 6.

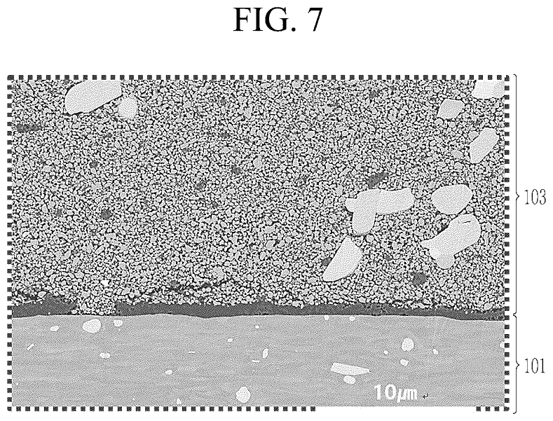

In addition, the positive electrode of Comparative Example 6 was taken an image of its cross-section with the scanning electron microscope (SEM), and the image is shown in FIG. 7.

Referring to FIG. 6, the positive electrode of Example 1 shows that Li₆CoO₄ and Li₅FeO₄, which were the irreversible additives, were relatively uniformly distributed in the coating layer.

On the other hand, referring to FIG. 7, the positive electrode of Comparative Example 6 shows that Li₅FeO₄, the irreversible additive, was nonuniformly distributed in the positive electrode active material layer due to a size difference of the positive electrode active material and the irreversible additive.

### Evaluation Example 2: Evaluation of Mixture Resistance and Interface Resistance

The positive electrode plates of Examples 1 to 3 and Comparative Examples 1 to 6 were prepared as samples, which were respectively measured with respect to mixture resistance and interface resistance by using a HIOKI resistance measuring device, and the results are shown in Table 1 below.

TABLE 1

| | Mixture resistance | Interface resistance |
|---|---|---|
| | (Ω · cm) | (Ω · cm²) |
| Example 1 | 9.7 | 11.02 |
| Example 2 | 9.6 | 11.03 |
| Example 3 | 9.6 | 10.89 |
| Comparative Example 1 | 10.4 | 11.13 |
| Comparative Example 2 | 10.5 | 11.02 |
| Comparative Example 3 | 10.6 | 10.98 |
| Comparative Example 4 | 10.5 | 11.01 |
| Comparative Example 5 | 10.2 | 11.03 |
| Comparative Example 6 | 11.2 | 12.31 |

Referring to Table 1 above, the positive electrodes of Examples 1 to 3 exhibited lower mixture resistance and lower or similar interface resistance, and thus lower overall resistance than Comparative Examples 1 to 6, which confirmed to exhibit high electrical conductivity. In particular, the positive electrode of Example 3 exhibited lower or similar mixture resistance and lower interface resistance than the positive electrodes of Examples 1 and 2, and thus the lowest overall resistance, which also confirmed high electrical conductivity.

### Evaluation Example 3: Evaluation of Initial Charge/Discharge Characteristics

The rechargeable lithium battery cells of Examples 1 to 3 and Comparative Examples 1 to 6 were charged to an upper limit voltage of 4.20V at a constant current of 0.1 C, and then to 0.1 C at the constant voltage, and discharged to a cut-off voltage of 2.50 V at 0.1 C at 25° C. for initial formation to measure initial charge capacity and initial discharge capacity, which are shown in Table 2 below.

TABLE 2

| | Initial charge | Initial discharge | Initial |
|---|---|---|---|
| | capacity | capacity | efficiency |
| | (mAh/g) | (mAh/g) | (%) |
| Example 1 | 177.7 | 152.4 | 85.7 |
| Example 2 | 176.5 | 152.0 | 86.1 |
| Example 3 | 177.9 | 152.6 | 85.7 |
| Comparative Example 1 | 160.1 | 145.5 | 90.9 |
| Comparative Example 2 | 172.2 | 151.1 | 87.7 |
| Comparative Example 3 | 175.6 | 152.0 | 86.5 |
| Comparative Example 4 | 173.4 | 151.2 | 87.2 |
| Comparative Example 5 | 174.2 | 151.3 | 86.8 |
| Comparative Example 6 | 173.2 | 151.2 | 87.3 |

Referring to Table 2 above, the rechargeable lithium battery cells of Examples 1 to 3, compared with those of Comparative Examples 1 to 6, were confirmed to exhibit high initial charge capacity and high or similar initial discharge capacity. Accordingly, the rechargeable lithium battery cells of Examples 1 to 3 were confirmed to exhibit desired or improved overall initial charge/discharge performance, compared with those of Comparative Examples 1 to 6.

In particular, the rechargeable lithium battery cell of Example 3 was confirmed to exhibit higher initial charge capacity and initial discharge capacity than the initial charge capacity and initial discharge capacity of Examples 1 and 2 and thus the most desired or improved initial charge/discharge performance.

On the other hand, the rechargeable lithium battery cells of Examples 1 to 3 exhibited lower initial efficiency than the initial efficiency of Comparative Examples 1 to 6, but this low initial efficiency was advantageous for securing performance of the rechargeable lithium battery cells, because when a coating layer was used an initial sacrificial positive electrode, the initial sacrificial positive electrode was initially activated to deposit lithium on a negative electrode and then did not participate in a reaction thereafter.

### Evaluation Example 4: Evaluation of Activation Efficiency

In order to evaluate an effect of shortening the initial activation time, the rechargeable lithium battery cells of Examples 1 to 3 and Comparative Examples 1 to 6 were measured with respect to activation efficiency of the activated batteries on the surface of the negative electrodes, and the results are shown in Table 3 below. Herein, the initial efficiency of the activated cells was measured as a ratio of discharge capacity (mAh/g) to charge capacity (mAh/g) at a point of repeating two cycles when an SEI film was uniformly formed after the initial charging and discharging of Evaluation Example 3. In addition, after the initial charging and discharging of Evaluation Example 3, the cycles were performed by repeating the charging and discharging within a voltage range of 2.50 V to 3.65 V at 1.0 C at 25° C.

TABLE 3

| | Initial activation efficiency (%) |
|---|---|
| Example 1 | 87.4 |
| Example 2 | 86.7 |
| Example 3 | 88.2 |
| Comparative Example 1 | 90.3 |
| Comparative Example 2 | 86.4 |
| Comparative Example 3 | 85.3 |
| Comparative Example 4 | 86.1 |
| Comparative Example 5 | 85.9 |
| Comparative Example 6 | 85.4 |

Referring to Table 3 above, the rechargeable lithium battery cells of Examples 1 to 3, compared with the rechargeable lithium battery cells of Comparative Examples 2 to 6, exhibit high initial activation efficiency. In particular, the rechargeable lithium battery cell of Example 3 exhibit higher initial activation efficiency than the rechargeable lithium battery cells of Examples 1 and 2.

On the other hand, the rechargeable lithium battery cell of Comparative Example 1, which positive electrode was manufactured without forming a coating layer and thus which had no sacrificial positive electrode and thus exhibited no initial efficiency deterioration due to the sacrificial positive electrode, exhibited high initial activation efficiency.

### Evaluation Example 5: Evaluation of Charge/Discharge and Cycle-Life Characteristics

The rechargeable lithium battery cells according to Examples 1 to 3 and Comparative Examples 1 to 6 were 20 times repeatedly charged and discharged within a voltage range of 2.50 V to 3.65 V at 1.0 C at 25° C. after the initial charging and discharging of Evaluation Example 3 to calculate a ratio of discharge capacity at the 20^{th} cycle to initial discharge capacity, and the results are shown in Table 4 below.

TABLE 4

| | 20th cycle capacity |
|---|---|
| | retention rate (%) |
| Example 1 | 102.4 |
| Example 2 | 102.1 |
| Example 3 | 102.6 |
| Comparative Example 1 | 100.2 |
| Comparative Example 2 | 101.1 |
| Comparative Example 3 | 101.4 |
| Comparative Example 4 | 101.1 |
| Comparative Example 5 | 101.2 |
| Comparative Example 6 | 101.0 |

Referring to Table 4, the rechargeable lithium battery cells of Examples 1 to 3, compared with the rechargeable lithium battery cells of Comparative Examples 1 to 6, exhibited a high 20th cycle capacity retention rate (%) and thus high cycle-life performance.

In particular, the rechargeable lithium battery cell of Example 3 exhibited a higher 20th cycle capacity retention rate than the rechargeable lithium battery cells of Examples 1 and 2, and thus the most desired or improved cycle-life performance.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

### DESCRIPTION OF SYMBOLS

| | |
|---|---|
| 101: positive electrode current collector | 102: coating layer |

103: positive electrode active material layer

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector;
a positive electrode active material layer on the positive electrode current collector and comprising a positive electrode active material; and
a coating layer between the positive electrode current collector and the positive electrode active material layer, and comprising an irreversible positive electrode additive,
wherein the irreversible positive electrode additive comprises at least one of a lithium cobalt-based oxide and a lithium nickel-based oxide, and further comprises a lithium iron-based oxide.

2. The positive electrode as claimed in claim 1, wherein the positive electrode active material comprises a lithium transition metal composite oxide.

3. The positive electrode as claimed in claim 2, wherein the positive electrode active material comprises a lithium iron phosphate-based compound.

4. The positive electrode as claimed in claim 3, wherein the lithium iron phosphate-based compound is represented by Chemical Formula 1A or Chemical Formula 2A: 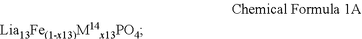
wherein, in Chemical Formula 1A, 0.90≤a13≤1.5, 0≤x13≤0.4, and M¹⁴ comprises at least one of Al, B, Ca, Ce, Cr, Cu, La, Mg, Mn, Mo, Nb, Ni, Si, Sn, Sr, Ti, V, W, Y, Zn, Zr, and a combination thereof, 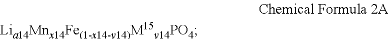
wherein, in Chemical Formula 2A, 0.90≤a14≤1.5, 0.1≤x14≤0.9, 0≤y13≤0.9, and M¹⁵ comprises at least one of Al, B, Ca, Ce, Cr, Cu, La, Mg, Mo, Nb, Ni, Si, Sn, Sr, Ti, V, W, Y, Zn, Zr, and a combination thereof.

5. The positive electrode as claimed in claim 3, wherein the lithium iron phosphate-based compound comprises at least one of LiFePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, and a combination thereof.

6. The positive electrode as claimed in claim 1, wherein the lithium iron-based oxide comprises at least one of Li₅FeO₄, LiFeO₂, LiFe₅O₈, LiFe₄O₆, LiFe₃O₄, and a combination thereof.

7. The positive electrode as claimed in claim 1, wherein the lithium cobalt-based oxide comprises at least one of LiCoO₂, Li₂CoO₃, Li₃Co₂O₆, Li₆CoO₄, and a combination thereof.

8. The positive electrode as claimed in claim 1, wherein the lithium nickel-based oxide comprises at least one of LiNiO₂, Li₂NiO₂, and a combination thereof.

9. The positive electrode as claimed in claim 1, wherein the irreversible positive electrode additive is included in an amount in a range of about 0.5 wt % to about 50 wt % based on 100 wt % of the coating layer.

10. The positive electrode as claimed in claim 1, wherein at least one of a lithium cobalt-based oxide and a lithium nickel-based oxide is included in an amount in a range of about 30 wt % to about 90 wt % based on 100 wt % of the irreversible positive electrode additive.

11. The positive electrode as claimed in claim 1, wherein the lithium iron-based oxide is included in an amount in a range of about 10 wt % to about 70 wt % based on 100 wt % of the irreversible positive electrode additive.

12. The positive electrode as claimed in claim 1, wherein the irreversible positive electrode additive comprises at least one of a lithium cobalt-based oxide, a lithium nickel-based oxide, and a lithium iron-based oxide.

13. The positive electrode as claimed in claim 12, wherein the lithium cobalt-based oxide is included in an amount in a range of about 1 wt % to about 80 wt % based on 100 wt % of the irreversible positive electrode additive.

14. The positive electrode as claimed in claim 12, wherein the lithium nickel-based oxide is included in an amount in a range of about 1 wt % to about 80 wt % based on 100 wt % of the irreversible positive electrode additive.

15. The positive electrode as claimed in claim 12, wherein the lithium iron-based oxide is included in an amount in a range of about 0.5 wt % to about 50 wt % based on 100 wt % of the irreversible positive electrode additive.

16. The positive electrode as claimed in claim 1, wherein a thickness of the coating layer is in a range of about 1 μm to about 300 μm.

17. The positive electrode as claimed in claim 1, wherein a thickness of the positive electrode active material layer is in a range of about 10 μm to about 300 μm.

18. The positive electrode as claimed in claim 1, wherein:
a thickness ratio of the coating layer to a total thickness of the coating layer and the positive electrode active material layer is in a range of about 2 thickness % to about 50 thickness %, and
a thickness ratio of the positive electrode active material layer to a total thickness of the coating layer and the positive electrode active material layer is in a range of about 50 thickness % to about 98 thickness %.

19. The positive electrode as claimed in claim 1, wherein:
an average particle diameter D₅₀ of at least one of the lithium cobalt-based oxide and lithium nickel-based oxide is in a range of about 0.5 μm to about 30 μm, and
an average particle diameter D₅₀ of the lithium iron-based oxide is in a range of about 0.5 μm to about 30 μm.

20. A rechargeable lithium battery, comprising:
the positive electrode as claimed in claim 1;
a negative electrode; and
an electrolyte.
